(19) United States
(12) Patent Application Publication
(10) Pub. No.: US 2005/0009461 A1
(43) Pub. Date: Jan. 13, 2005

(54) Drive adapter for food processor

(76) Inventor: Jeffrey W. Palese, North Ridgeville, OH (US)

Correspondence Address: Matthew M. Shaheen;Tarolli, Sundheim, Covell & Tummino, L.L.P., 1111 Leader Building, 526 Superior Avenue, Cleveland, OH, 44114, US

(21) Appl. No.: 10/609,730

(22) Filed: Jun. 30, 2003

(51) Int. Cl. A22C 9/00

(52) U.S. Cl. 452/142

(57) ABSTRACT

A food processing apparatus (10) includes a food processing unit (20) having a drive shaft (46) rotatable to effectuate operation of the food processing unit. The drive shaft (46) has a portion adapted for connection with a crank handle (60). The apparatus (10) also includes an adapter (100) connectable with the food processing unit (20). The adapter (100) is adapted to operatively connect the portion of the drive shaft (46) with an output shaft (86) of a drive unit (80) to operatively couple the food processing unit (20) with the drive unit.

### FIELD OF THE INVENTION

The present invention relates to an adapter for adapting a manually operated food processing apparatus for connection with an electric drive unit for automatic operation.

### BACKGROUND OF THE INVENTION

Food processing devices are widely known. The known food processing devices are used to perform a variety of functions, such as mixing, grinding, chopping, cutting, slicing, grating, and straining. These devices range in size from small personal or home use devices to large floor-standing commercial or industrial devices.

Food processing devices intended for personal or home use are typically designed to be somewhat portable in nature. These personal food processing devices may be powered manually, by means such as a handle or hand crank, or may be automated and powered by an electric motor. Since automated food processing devices are typically more expensive than manually operated devices, it may be cost prohibitive to purchase automated versions of the various food processing devices.

One of the many known food processing devices is a meat grinder. Meat grinders are typically automated units driven by an electric motor. The known meat grinders typically include a grinding unit that includes the components for receiving unground meat, grinding the meat, and discharging a ground meat product. These meat grinders also include a drive unit that includes an electric motor for driving the grinding unit.

The grinding unit may be separate from, and connectable with, the drive unit. The grinding unit typically includes a drive shaft having an end portion that protrudes from the grinding unit. The drive unit typically includes an exposed output shaft. The drive shaft of the grinding unit mates with the output shaft of the drive unit when the grinding unit is connected with the drive unit.

Typically, the drive shaft of the grinding unit has a male end connector and the output shaft of the drive unit has a female end connector. In some instances, however, the drive shaft could have a female end connector and the output shaft could have a male end connector. This depends on the manufacturer of the particular meat grinder. Each meat grinder manufacturer typically incorporates its own unique configuration of the male/female end connectors of the drive/output shafts.

### SUMMARY OF THE INVENTION

According to one aspect of the invention, the present invention relates generally to a food processing apparatus comprising a food processing unit that has a drive shaft rotatable to effectuate operation of the food processing unit. The drive shaft has a portion adapted for connection with a crank handle. The apparatus also comprises an adapter connectable with the food processing unit. The adapter is adapted to operatively connect the portion of the drive shaft with an output shaft of a drive unit to operatively couple the food processing unit with the drive unit.

According to another aspect of the invention, the present invention relates generally to an adapter for a food processing apparatus. The food processing apparatus comprises a food processing unit that has a drive shaft rotatable to effectuate operation of the food processing unit and a crank handle connectable with the drive shaft. The adapter comprises housing means connectable with the food processing apparatus and coupling means connectable with the drive shaft. The coupling means is adapted to connect with an output shaft of a drive unit to operatively couple the drive shaft of the food processing unit with the output shaft of the drive unit.

According to a further aspect of the invention, the present invention relates generally to a food processing apparatus comprising a food processing unit. The food processing unit comprises a drive shaft rotatable to effectuate operation of the food processing unit. A first adapter is connectable with the food processing unit. A second adapter is connectable with a drive unit. The first and second adapters are connectable with each other to operatively couple the food processing unit with the drive unit.

### BRIEF DESCRIPTION OF THE DRAWINGS

The foregoing and other features of the invention will become apparent to one skilled in the art to which the invention relates upon consideration of the following description of the invention with reference to the accompanying drawings, in which:

FIG. 1 is a perspective view of a manually operated food processing apparatus, according to the present invention;

FIG. 2 is an exploded perspective view of a portion of the food processing apparatus of FIG. 1 together with an apparatus for adapting the food processing apparatus for use with an electric drive unit, according to a first embodiment of the present invention;

FIG. 3 is a perspective view of a portion of the apparatus of FIG. 2 illustrating parts in an assembled condition;

FIG. 4 is a schematic side elevation view of the apparatus of FIG. 2 in an assembled condition;

FIG. 5 is an exploded perspective view of the apparatus of FIG. 1 adapted for use with an electric drive unit having a different configuration, according to a second embodiment of the present invention;

FIG. 6A is a perspective view of a portion of an electric drive unit having yet another configuration;

FIGS. 6B-6E illustrate an apparatus for adapting the food processing apparatus for use with the electric drive unit of FIG. 6A, according to a third embodiment of the present invention; and

FIGS. 7A-7B illustrate an apparatus for adapting the food processing apparatus for use with an electric drive unit having still another configuration, according to a fourth embodiment of the present invention.

### DETAILED DESCRIPTION OF THE INVENTION

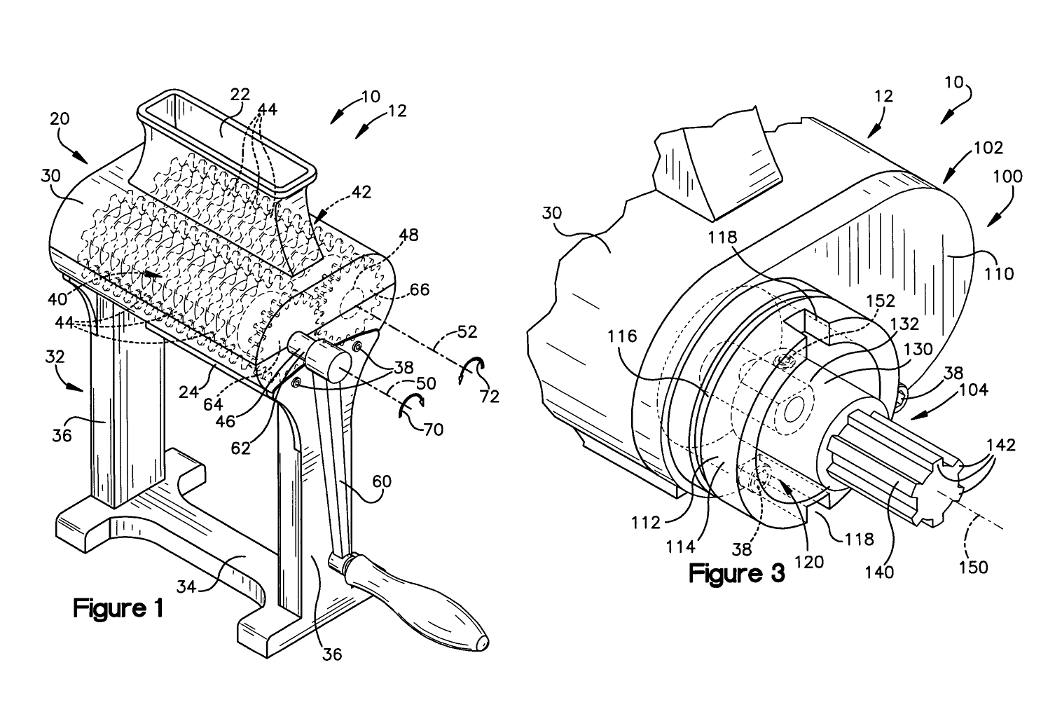

Referring to FIG. 1, the present invention relates to an apparatus 10 for processing a food product. In the embodiment of FIGS. 1-4, the food processing apparatus 10 comprises a meat tenderizer 12. The food processing apparatus 10 could, however, be an apparatus for performing alternative food processing functions, such as food grinding, cutting, chopping, grating, peeling, juicing, straining, etc.

The meat tenderizer 12 is operable to tenderize a meat product by repeatedly piercing or otherwise cutting into the meat. The meat tenderizer 12 includes a food processing unit in the form of a tenderizer unit 20 that performs the tenderizing operation of the meat tenderizer. The tenderizer unit 20 includes an intake portion 22 for receiving a meat product (not shown), such as a beef steak, or any other meat product for which tenderizing is desired. The tenderizer unit 20 also includes a discharge portion 24 that directs the tenderized meat product out of the tenderizer unit.

Referring to FIG. 1, the meat tenderizer 12 may include a base 32 for supporting the tenderizer unit 20. The tenderizer unit 20 includes a housing 30 to which the base 32 is connectable to support the tenderizer unit. The base 32 may have any configuration suitable for supporting the tenderizer unit 20. In the example embodiment of FIG. 1, the base 32 includes a horizontally oriented foot plate portion 34 and a pair of support members 36 that extend vertically from opposite ends of the foot plate portion. The support members 36 are connected with the housing 30 by means 38, such as machine screws.

The tenderizer unit 20 includes first and second blade assemblies 40 and 42, respectively, supported in the housing 30. Each of the blade assemblies 40 and 42 includes a plurality of blades 44 fixed to and rotatable with a shaft. The blades 44 of the first blade assembly 40 are fixed to and rotatable with a first shaft 46. The blades 44 of the second blade assembly 42 are fixed to and rotatable with a second shaft 48. Each of the blades 44 has a generally circular central portion with a plurality of cutting blades spaced about an annular edge of the central portion.

The first blade assembly 40 is rotatable about a longitudinal axis 50 of the first shaft 46. The second blade assembly 42 is rotatable about a longitudinal axis 52 of the second shaft 48. The first and second shafts 46 and 48, and thus the first and second axes 50 and 52, are spaced from each other and extend generally parallel to each other. The first and second blade assemblies 40 and 42 are positioned relative to each other such that their respective blades 44 are positioned close to each other. The blades 44 of the first and second blade assemblies 40 and 42 may even be interlaced; the blades of the first blade assembly extending between adjacent blades of the second blade assembly, and vice versa.

The meat tenderizer 12 includes a crank handle 60 that is operable to impart manual rotation of the first and second blade assemblies 40 and 42 about their respective axes 50 and 52. The crank handle 60 is connected with a portion 62 of the first shaft 46 that protrudes from the housing 30. The first blade assembly 40 includes a first gear or cog 64 fixed to the first shaft 46 and rotatable with the first shaft about the first axis 50. The second blade assembly 42 includes a second gear or cog 66 fixed to the second shaft 48 and rotatable with the second shaft about the second axis 52. The first and second cogs 64 and 66 each include a series of teeth that are positioned in meshing engagement with each other.

Rotation of the first and second blade assemblies 40 and 42 may be imparted by manually cranking the crank handle 60. The crank handle 60 is rotated about the axis 50 in a clockwise direction indicated generally by the arrow labeled 70 in FIG. 1. The first blade assembly 40 is thus rotated about the first axis 50 in the clockwise direction 70. As the first blade assembly 40 rotates in the clockwise direction 70, the first cog 64 imparts a force on the second cog 66 that urges the second cog, and thus the second blade assembly 42, to rotate in a counterclockwise direction. This counterclockwise direction is indicated generally by the arrow labeled 72 in FIG. 1.

When a meat product is introduced through the intake portion 22 into the tenderizer unit 20 of the meat tenderizer 12, the meat product engages the blades 44 of the first and second blade assemblies 40 and 42. The blades 44 of the first and second blade assemblies 40 and 42, rotating in their respective opposite directions 70 and 72, tend to grab onto the meat product and pull the meat product between the blade assemblies and through the tenderizer unit 20. As the meat product travels through the tenderizer unit 20, the blades 44 cut into and tenderize the meat product. The meat product then exits the meat tenderizer 12 through the discharge portion 24.

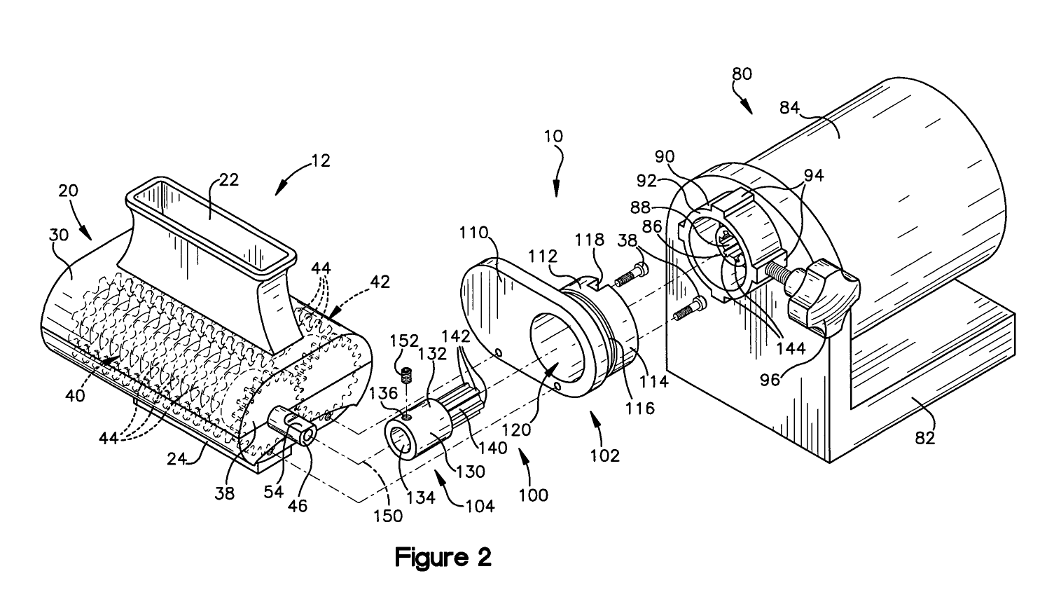

Referring to FIG. 2, according to the present invention, an adapter 100 is operative to connect the meat tenderizer 12 with an electric drive unit 80. The electric drive unit 80 may be any known drive unit for providing a power source for culinary appliances, such as a meat grinder or a mixer. As shown in FIG. 2, the drive unit 80 may include a base 82 that supports an electric motor 84. The motor 84 is operative to rotate an output shaft 86 of the drive unit 80. The output shaft 86 includes a receptacle 88 for receiving a member, such as a shaft, for which it may be desired to rotate via the drive unit 80.

The drive unit 80 also includes a collar portion 90 for receiving and connecting with a device, such as a culinary appliance, for which power is to be provided by the drive unit. The collar portion 90 includes a side wall 92 that has a generally cylindrical configuration. The side wall 92 may include ribs 94 spaced about the circumference of the side wall that may help improve the structural integrity of the collar portion 90. The collar portion 90 may also include a locking screw 96 that is extendable through the side wall 92.

Referring to FIGS. 2 and 3, the adapter 100 includes a frame portion 102 and a coupling portion 104. The adapter 100 may be constructed of any suitable material or combination of materials, such as stainless steel, aluminum, plastic, etc. The frame portion 102 includes a base plate 110, having a generally elongate configuration, and a sleeve 112. The sleeve 112 includes a generally cylindrical side wall 114 that extends from a planar surface of the base plate 110. The side wall 114 may include a groove 116 that extends into an outer surface of the side wall along at least a portion of a circumference of the side wall. The sleeve 112 may also include at least one notch 118 that extends longitudinally into an end surface of the side wall 114. A cylindrical bore 120 is at least partially defined by the side wall 114 and extends through the sleeve 112 and the base plate 110.

The coupling portion 104 has a female end portion 130 and a male end portion 140 aligned with each other along an axis 150. The female end 130 has a generally cylindrical outer surface 132 and a generally cylindrical female receptacle 134 (see FIG. 2) bored into the female end along the axis 150. The female end 130 may also include a threaded aperture 136 that extends into the female end from an outer surface of the female end to the female receptacle 134.

The male end 140 of the coupling portion 104 of the adapter 100 comprises a shaft with a generally cog shaped cross-section. The male end 140 includes a series of teeth or ribs 142 that extend along the male end in a direction generally parallel to the axis 150.

The crank handle 60 (FIG. 1) of the meat tenderizer 12 is removable from the drive shaft 46. This may be done, for example, by removing a set screw that helps connect the crank handle 60 to the drive shaft 46. The base 32 is removable from the housing 30 by removing the machine screws 38. This leaves the tenderizer unit 20 in the condition shown in FIGS. 2 and 3.

Referring to FIG. 2, assembly of the tenderizer unit 20, adapter 100, and drive unit 80 is indicated generally by dot-dash lines. As shown in FIGS. 2 and 3, the drive shaft 46 may include a flat 54. The female portion 130 of the coupling portion 104 is adapted for connection with the drive shaft 46. The female receptacle 134 has a diameter sufficient to permit insertion of the drive shaft 46 therein. The receptacle 134 may also include a flat (not shown) that corresponds to the flat 54 of the drive shaft 46. Once the drive shaft 46 is inserted into the receptacle 134 of the female end 130, means 152, such as a set screw, may be installed in the threaded opening 136 to fixedly connect the coupling portion 104 with the drive shaft. The coupling portion 104 of the adapter 100 thus may be connected with the drive shaft 46 of the tenderizer unit 20 in place of the crank handle 60.

The frame portion 102 of the adapter 100 is adapted for connection with the housing 30 of the tenderizer unit 20. As indicated in FIG. 2 and shown in FIG. 3, the base plate 110 may be positioned against an end wall 38 of the housing 30 such that the drive shaft 46, with the coupling portion 104 connected therewith, extends through the bore 120. With the frame portion 102 positioned as shown in FIG. 3, the machine screws 38 may be used to fixedly connect the base plate 110, and thus the frame portion 102, to the housing 30 of the tenderizer unit 20. The adapter 100, and more particularly the frame portion 102, thus may be connectable with the tenderizer unit 20 in place of the base 32.

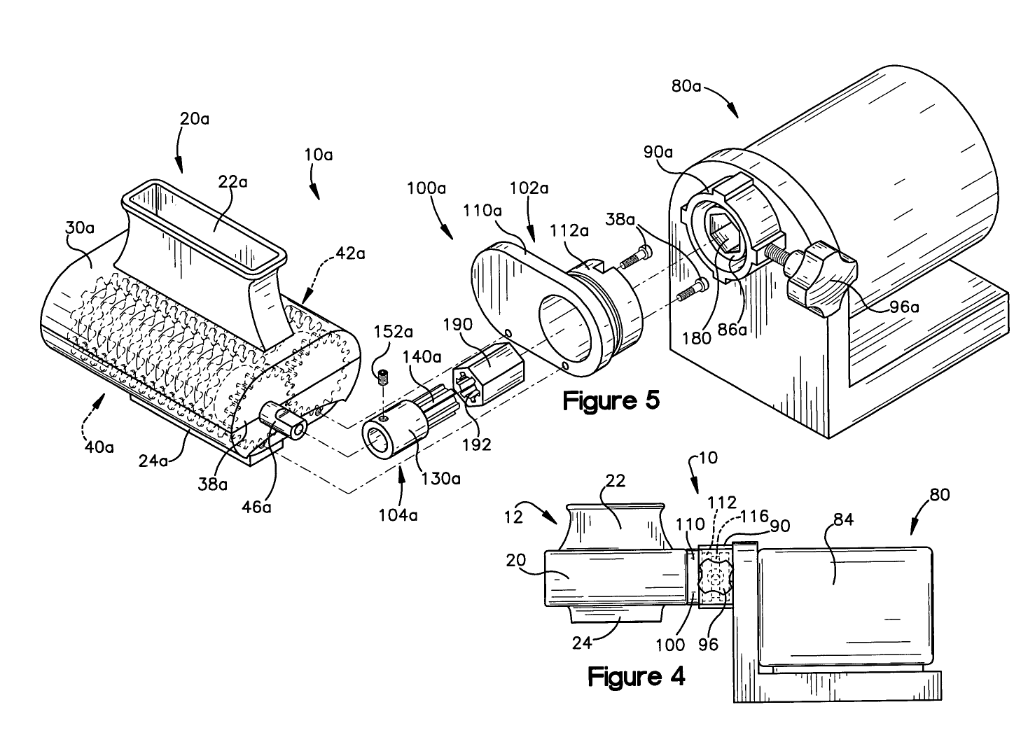

In the assembled condition of FIG. 3, the adapter 100 is connected with the tenderizer unit 20 of the meat tenderizer 12. In this assembled condition, the drive shaft 46 may be rotated via the coupling portion 104 to effectuate operation of the blade assemblies 40 and 42, as described above. Also, in this assembled condition, the tenderizer unit 20 may be supported via the frame portion 102. More particularly, the tenderizer unit 20 may be supported by the drive unit 80 via a connection between the sleeve portion 112 of the adapter 100 and the collar portion 90 of the drive unit. This is shown in FIG. 4.

Referring to FIGS. 2 and 4, the sleeve portion 112 of the adapter 100 is receivable in the collar portion 90 of the drive unit 80. The outside diameter of the sleeve portion 112 may have a close fit with the inside diameter formed by the side wall 92 of the collar portion 90. At least one of the notches 118 in the side wall 114 of the collar portion 90 may receive a lug (not shown) that projects into the collar portion from the side wall 92 to help block the frame portion 102, and thus the tenderizer unit 20, from rotational movement relative to the drive unit 80.

As the sleeve portion 112 of the adapter 100 is inserted into the collar portion 90 of the drive unit 80, the male portion 140 of the of the coupling portion 104 enters the receptacle 88 of the output shaft 86. As shown in FIG. 2, the cog shape of the male portion 140 mates with the cog shape of the receptacle 88. The ribs 142 of the male portion 140 mesh with teeth or ribs 144 of the receptacle 88 to help prevent rotational movement of the coupling portion 104 relative to the output shaft 86.

Once the tenderizer unit 20 and the adapter 100 are in the position illustrated in FIG. 4, the lock screw 96 may be tightened to help fixedly connect the tenderizer unit with the drive unit 80 via the adapter 100. In doing so, the lock screw 96 may engage the sleeve 112 in the groove 116. The adapter 100 thus operatively connects the tenderizer unit 20 to the drive unit 80.

With the apparatus 10 in the assembled condition of FIG. 4, the drive unit 80 may be activated to energize the electric motor 84, thus causing rotation of the output shaft 86. The coupling portion 104 of the adapter 100, being connected with the output shaft 86, rotates with the output shaft. The drive shaft 46 of the tenderizer unit 20, being coupled with the coupling portion 104 of the adapter 100, rotates with the coupling portion and the output shaft 86, which causes rotation of the first and second blade assemblies 40 and 42. A food product (e.g., beef steak) may thus be fed through the intake portion 22 into the tenderizer unit 20 to tenderize the food product. The tenderized food product exits the tenderizer unit 20 through the discharge portion 24.

A second embodiment of the present invention is illustrated in FIG. 5. The second embodiment of the invention is similar to the first embodiment of the invention illustrated in FIGS. 1-4. Accordingly, numerals similar to those of FIGS. 1-4 will be utilized in FIG. 5 to identify similar components, the suffix letter “a” being associated with the numerals of FIG. 5 to avoid confusion. The second embodiment of the present invention is similar to the first embodiment (FIGS. 1-4), except that the adapter includes a fitting for facilitating its use with a drive unit having an output shaft different than the output shaft of the drive unit of FIGS. 1-4.

Referring to FIG. 5, the drive unit 80a includes an output shaft 86a having a recess 180 that has a hexagonal cross section. According to the second embodiment of the present invention, the adapter 100a of the apparatus 10a includes a fitting 190 for facilitating use of the adapter to operatively connect the tenderizer unit 20a with the drive unit 80a.

The fitting 190 comprises a length of material, such as bar stock material, that has a hexagonal cross-section. The fitting 190 thus has a generally hexagonal configuration with a six-sided outer surface. The hexagonal configuration of the fitting 190 is sized and dimensioned for being received in the recess 180 of the output shaft 86a. The fitting 190 includes a recess 192 that has a cog shaped cross-section sized and dimensioned to receive the male end 140a of the coupling portion 104a.

The apparatus 10a is assembled in a manner similar to that of the apparatus 10 (FIGS. 1-4) of the first embodiment, except that, in the second embodiment, the fitting 190 (FIG. 5) is fitted onto the male portion 140a of the coupling portion 104a and is received in the recess 180 of the output shaft 86a.

The female portion 130a of the coupling portion 104a is connected with the drive shaft 46a of the tenderizer portion 20a, e.g., by means 152a, such as a set screw. The coupling portion 104a of the adapter 10a may therefore be connectable with the drive shaft 46a of the tenderizer unit 20a in place of the crank handle (see FIG. 1).

The frame portion 102a (FIG. 5) of the adapter 10a is then connected with the housing 30a of the tenderizer unit 20a by means, such as the machine screws 38a. More particularly, the base plate 110a is connected to the end surface 38a of the housing 30a. The adapter 100a thus may be connectable with the tenderizer unit 20a in place of the base.

The sleeve portion 112a of the adapter 100a is receivable in the collar portion 90a of the drive unit 80a. As the sleeve portion 112a of the adapter 10a is inserted into the collar portion 90a of the drive unit 80a, the fitting 190, being fitted over the male portion 140a of the of the coupling portion 104a, enters the receptacle 180 of the output shaft 86a. The hexagonal shape of the fitting 190 mates with the hexagonal shape of the receptacle 180. The lock screw 96a may then be tightened to help fixedly connect the tenderizer unit 20a with the drive unit 80a via the adapter 100a. The adapter 100a thus operatively connects the tenderizer unit 20a to the drive unit 80a.

The tenderizer unit 20a may be supported by the drive unit 80a via the adapter 100a. More particularly, the tenderizer unit 20a may be connected with the frame portion 102a, which may be connected with the drive unit 80a via a connection with the sleeve portion 112a. The drive unit 80a may be activated to energize the electric motor 84a, thus causing rotation of the output shaft 86a. The coupling portion 104a of the adapter 100a, being connected with the output shaft 86a, rotates with the output shaft. The drive shaft 46a of the tenderizer unit 20a, being coupled with the coupling portion 104a of the adapter 100a, rotates with the coupling portion and the output shaft 86a, which causes rotation of the first and second blade assemblies 40a and 42a. A food product (e.g., beef steak) may thus be fed through the intake portion 22a into the tenderizer unit 20a to tenderize the food product. The tenderized food product exits the tenderizer unit 20a through the discharge portion 24a.

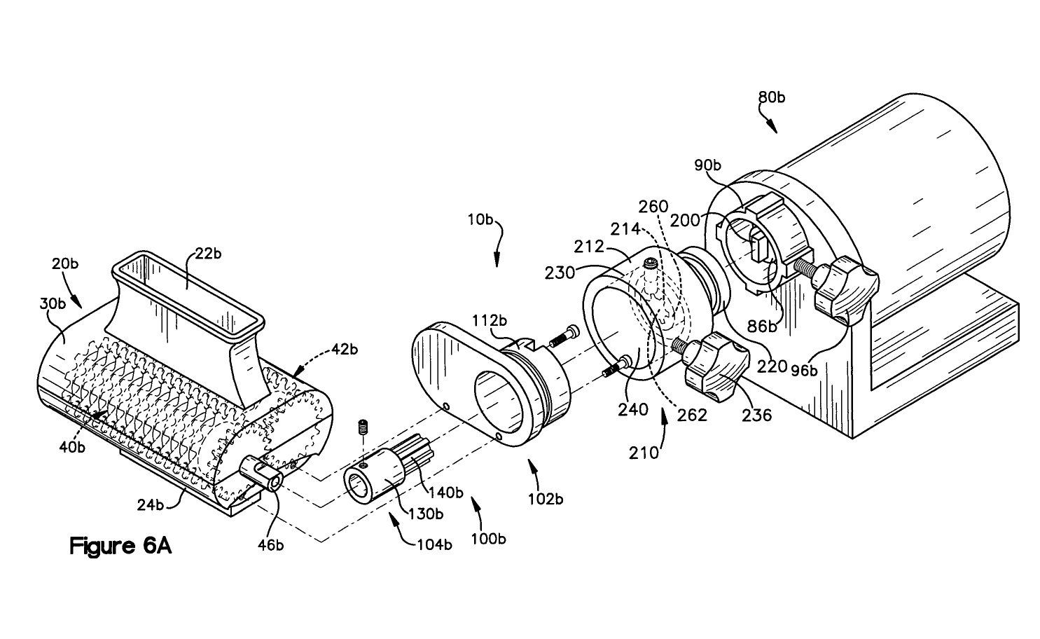

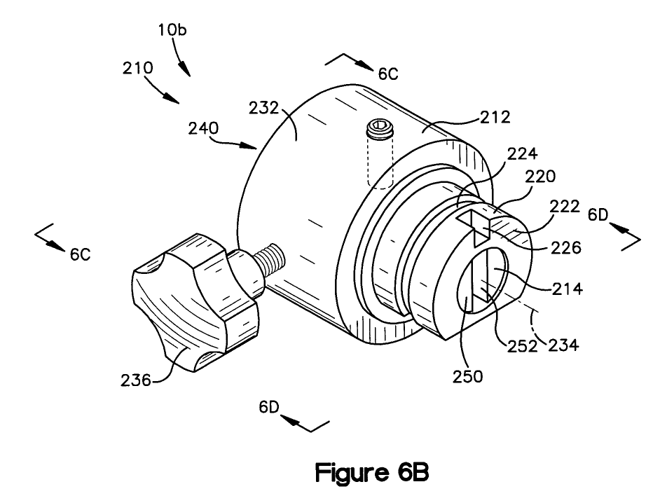

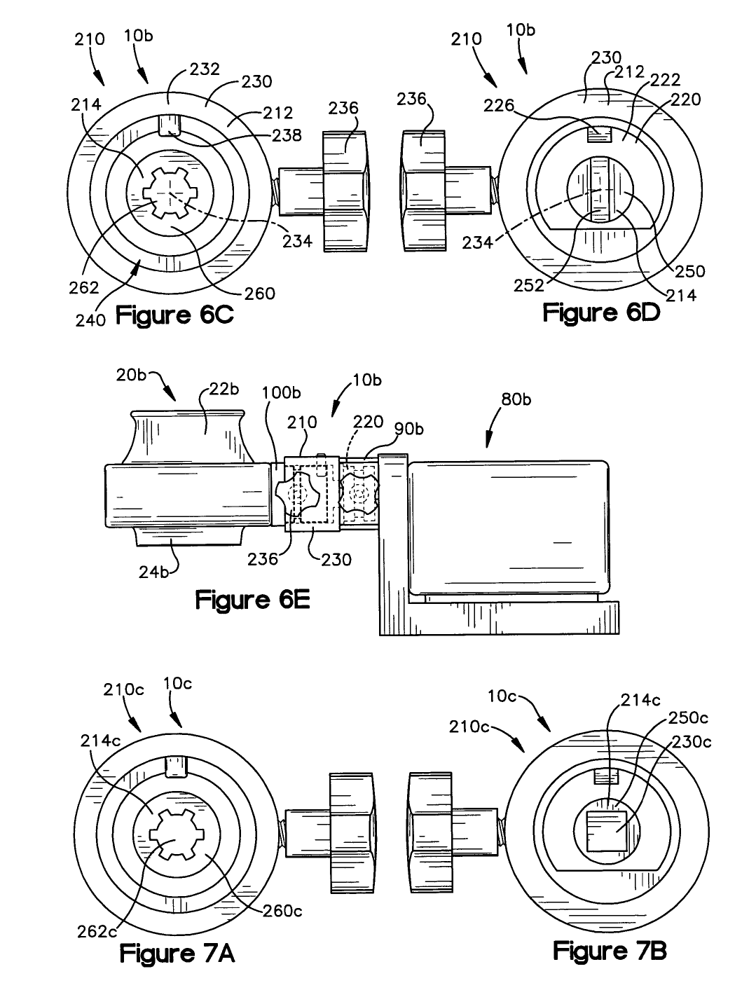

A third embodiment of the present invention is illustrated in FIGS. 6A-6E. The third embodiment of the invention is similar to the first embodiment of the invention illustrated in FIGS. 1-4. Accordingly, numerals similar to those of FIGS. 1-4 will be utilized in FIGS. 6A-6E to identify similar components, the suffix letter “b” being associated with the numerals of FIGS. 6A-6E to avoid confusion. The third embodiment of the present invention is similar to the first embodiment (FIGS. 1-4), except that the apparatus includes a second adapter for facilitating use of the apparatus with a drive unit having an output shaft different than the output shaft of the drive unit of FIGS. 1-4.

Referring to FIG. 6A, the drive unit 80b includes an output shaft 86b with a male portion 200 having a generally rectangular cross-section. According to the third embodiment of the present invention, the apparatus 10b (FIGS. 6A-6E) includes a second adapter 210 connectable with the output shaft 86b to facilitate use with an adapter 100b similar to the adapter of the first embodiment (see FIGS. 1-4). The second adapter 210 thus may help to operatively connect the tenderizer unit 20b with the drive unit 80b.

The second adapter 210 includes a frame portion 212 and a coupling portion 214. The coupling portion 214 may be supported by the frame portion 212 by means, such as a bearing or bushing, for rotation relative to the frame portion. Alternatively, the coupling portion 214 may be a part separate from the frame portion 212.

The frame portion 212 has a sleeve portion 220 and a collar portion 230. The sleeve portion 220 has a generally cylindrical side wall 222 (FIGS. 6B-6D) that may include a groove 224 extending into an outer surface of the side wall along at least a portion of a circumference of the side wall. The side wall 222 may also include one or more notches 226 that extend into an end surface of the side wall.

The collar portion 230 has a generally cylindrical side wall 232. The side wall 232 of the collar portion 230 and the side wall 222 of the sleeve portion 220 are aligned with each other along a central axis 234 of the second adapter 210. The second adapter 210 may also include a lock screw 236 that is threaded through the side wall 232 of the collar portion 230. A central bore 240 of the second adapter 210 extends through the sleeve portion 220 and the collar portion 230. The central bore 240 may have a generally cylindrical configuration. The collar portion 230 may include a lug 238 (see FIG. 6C) that extends from the side wall 232 into the central bore 240.

The coupling portion 214 of the second adapter 210 has a first end portion 250 and an opposite second end portion 260. The first end portion 250 is adapted for positioning in the cylindrical bore 240 in the sleeve portion 220 of the second adapter 210. The first end portion 250 includes a receptacle 252 for mating with and receiving the male portion 200 of the output shaft 86b of the drive unit 80b. The receptacle 252 is a female fitting having a generally rectangular cross-section, as shown in FIGS. 6B and 6D.

The second end portion 260 is adapted for positioning in the cylindrical bore 240 in the collar portion 230 of the second adapter 210. The second end portion 260 includes a receptacle 262 for mating with and receiving the male portion 140b (FIG. 6A) of the coupling portion 104b of the adapter 100b. The receptacle 262 is a female fitting having a generally cog shaped cross-section, as shown in FIGS. 6A and 6C.

The apparatus 10b is assembled in a manner similar to that of the apparatus 10 (FIGS. 1-4) of the first embodiment, except that, in the third embodiment, the second adapter 210 is fitted with the collar portion 90b and output shaft 86b of the drive unit 80b and the male portion 140b of the adapter 10b is received in the recess 262 of the second coupling portion 260. This is shown in FIG. 6A.

The female portion 130b of the coupling portion 104b is connected with the drive shaft 46b of the tenderizer portion 20b. The coupling portion 104b of the adapter 100b may therefore be connected with the drive shaft 46b of the tenderizer unit 20b in place of the crank handle (see FIG. 1).

The frame portion 102b (FIG. 6A) of the adapter 100b is then connected with the housing 30b of the tenderizer unit 20b. The adapter 100b thus may be connected with the tenderizer unit 20b in place of the base (see FIG. 1).

The sleeve portion 220 of the second adapter 212 is receivable in the collar portion 90b of the drive unit 80b. As the sleeve portion 220 is inserted into the collar portion 90b, the male end 200 of the output shaft 86b enters the receptacle 252 (see FIG. 6B) of the first end portion 250 of the second coupling portion 214. The rectangular male end 200 mates with the rectangular shape of the receptacle 252. The lock screw 96b may then be tightened to help fixedly connect the second adapter 210 with the drive unit 80b.

The sleeve portion 112b (FIGS. 6A and 6E) of the adapter 100b is receivable in the collar portion 230 of the second adapter 210. As the sleeve portion 112b of the adapter 100b is inserted into the collar portion 230 of the second adapter 210, the male end 140b of the coupling portion 104b enters the receptacle 262 of the second end portion 260 of the second coupling portion 214. The cog shaped male end 140b mates with the cog shape of the receptacle 262. The lock screw 236 may then be tightened to help fixedly connect the adapter 100b with the second adapter 210. The adapter 100b in combination with the adapter 210 thus operatively connects the tenderizer unit 20b to the drive unit 80b.

The drive shaft 46b may be rotated via the coupling portion 104b and the second coupling portion 214 to effectuate operation of the blade assemblies 40b and 42b. Also, the tenderizer unit 20b may be supported via the frame portion 102b and the second frame portion 212.

The drive unit 80b may be activated to cause rotation of the output shaft 86b. The coupling portion 104b of the adapter 100b, being connected with the output shaft 86b via the second coupling portion 214, rotates with the output shaft. The drive shaft 46b of the tenderizer unit 20b, being coupled with the output shaft 86b, rotates with the output shaft which causes rotation of the first and second blade assemblies 40b and 42b. A food product (e.g., beef steak) may thus be fed through the intake portion 22b into the tenderizer unit 20b to tenderize the food product. The tenderized food product exits the tenderizer unit 20b through the discharge portion 24b.

A fourth embodiment of the present invention is illustrated in FIGS. 7A-7B. The fourth embodiment of the invention is similar to the third embodiment of the invention illustrated in FIGS. 6A-6E. Accordingly, numerals similar to those of FIGS. 6A-6E will be utilized in FIGS. 7A-7B to identify similar components, the suffix letter “c” being associated with the numerals of FIGS. 7A-7B to avoid confusion. The fourth embodiment of the present invention is similar to the third embodiment (FIGS. 6A-6E), except that the second coupling portion of the second adapter includes a recess having a different configuration.

Referring to the apparatus 10c of FIG. 7B, the first end portion 250c of the second coupling portion 214c of the second adapter 210c includes a recess 300 that has a square cross-section. The recess 300 is adapted to receive a male portion (not shown) of the output shaft of the drive unit that has a square cross-section. The second end portion 260c (FIG. 7A) of the second coupling portion 214c has a recess 262c with a cog shaped cross-section. The second adapter 210c, in combination with an adapter similar or identical to the adapter of the third embodiment (see that adapter 100b of FIGS. 6A-6E) may thus operatively connect the tenderizer unit to the drive unit (not shown in FIGS. 7A and 7B).

From the above description of the invention, those skilled in the art will perceive improvements, changes and modifications in the invention. For example, in the embodiments described herein, the frame portion and coupling portion of the adapter are separate from each other and separately connectable with the tenderizer portion. It will be appreciated, however, that the frame portion may be adapted to support the coupling portion for rotation relative to the frame portion. This support could be facilitated, for example, by means such as a bearing or bushing. In this instance, the adapter may be assembled to have a unitary construction. These and other such improvements, changes and modifications within the skill of the art are intended to be covered by the appended claims.

1. A food processing apparatus comprising:
a food processing unit having a drive shaft rotatable to effectuate operation of said food processing unit, said drive shaft having a portion adapted for connection with a crank handle; and
an adapter connectable with said food processing unit, said adapter being adapted to operatively connect said portion of said drive shaft with an output shaft of a drive unit to operatively couple said food processing unit with the drive unit.

2. The apparatus recited in claim 1, wherein said food processing apparatus includes a crank handle connectable with said drive shaft, said crank handle being manually operable to effectuate rotation of said drive shaft, said adapter being connectable with said drive shaft in place of said crank handle.

3. The apparatus recited in claim 1, wherein said food processing unit comprises a base connectable with said food processing unit to support said food processing unit for manual operation, said adapter being connectable with said food processing unit in place of said base.

4. The apparatus recited in claim 1, wherein said adapter comprises:
a frame portion connectable with said food processing unit; and
a coupling portion supported by said frame portion for rotation relative to said frame portion;
said coupling portion having a first end adapted for connection with the drive shaft of said food processing unit, said coupling portion having a second end opposite said first end, said second end being adapted for connection with the output shaft of the drive unit.

5. The apparatus recited in claim 4, wherein said first end of said coupling portion comprises a female receptacle for receiving and mating with a male end portion of the drive shaft of said food processing unit, and said second end of said coupling portion comprises a male portion for being received in and mating with a female receptacle of the drive unit.

6. The apparatus recited in claim 5, wherein said female receptacle of said first end of said coupling portion comprises a recess having a hexagonal cross-section for receiving and mating with a male end portion of the drive shaft having a hexagonal cross-section.

7. The apparatus recited in claim 5, wherein said female receptacle of said first end of said coupling portion comprises a recess having a rectangular cross-section for receiving and mating with a male end portion of the drive shaft having a rectangular cross-section.

8. The apparatus recited in claim 5, wherein said female receptacle of said first end of said coupling portion comprises a recess having a cog-shaped cross-section for receiving and mating with a male end portion of the drive shaft having a cog-shaped cross-section.

9. The apparatus recited in claim 4, wherein said frame portion of said adapter comprises a sleeve portion that substantially encircles said second end of said of said coupling portion, said sleeve portion being adapted for being received by and connected with the drive unit to help support said adapter on the drive unit.

10. The apparatus recited in claim 1, wherein said adapter comprises:
first adapter portion comprising a first frame portion connectable with said food processing unit and a first coupling portion supported by said first frame portion for rotation relative to said first frame portion, said first coupling portion having a first end adapted for connection with the drive shaft of said food processing unit, said first coupling portion having a second end opposite said first end; and
second adapter portion comprising a second frame portion connectable with the drive unit and a second coupling portion supported by said second frame portion for rotation relative to said second frame portion, said second coupling portion having a first end adapted for connection with an output shaft of the drive unit and an opposite second end adapted for connection with said second end of said first coupling portion, said first and second adapter means operatively coupling said food processing unit with the drive unit.

11. The apparatus recited in claim 1, wherein said drive unit comprises an electric drive unit.

12. An adapter for a food processing apparatus, the food processing apparatus including a food processing unit having a drive shaft rotatable to effectuate operation of the food processing unit and a crank handle connectable with the drive shaft, said adapter comprising:
housing means connectable with the food processing apparatus; and
coupling means connectable with the drive shaft, said coupling means being adapted to connect with an output shaft of a drive unit to operatively couple the drive shaft of the food processing unit with the output shaft of the drive unit.

13. The adapter recited in claim 12, wherein the food processing apparatus includes a base that supports the food processing unit for manual operation via the crank handle, said housing means comprising a portion connectable with the food processing unit in place of the base.

14. The adapter recited in claim 12, wherein said housing means further comprises a portion connectable with the drive unit, the food processing unit being supported on the drive unit by said housing means when said housing means is connected with the food processing unit and the drive unit.

15. The apparatus recited in claim 12, wherein said drive unit comprises an electric drive unit.

16. A food processing apparatus comprising:
a food processing unit having a drive shaft rotatable to effectuate operation of said food processing unit;
a first adapter connectable with said food processing unit; and
a second adapter connectable with a drive unit, said first and second adapters being connectable with each other to operatively couple said food processing unit with said drive unit.

17. The apparatus recited in claim 16, wherein:
said first adapter comprises a first frame portion connectable with said food processing unit and a first coupling portion supported by said first frame portion for rotation relative to said first frame portion, said first coupling portion having a first end adapted for connection with said drive shaft of said food processing unit, said first coupling portion having a second end opposite said first end; and
said second adapter comprises a second frame portion connectable with a drive unit and a second coupling portion supported by said second frame portion for rotation relative to said second frame portion, said second coupling portion having a first end adapted for connection with an output shaft of said drive unit and an opposite second end adapted for connection with said second end of said first coupling portion.
